(19) United States
(12) Patent Application Publication
(10) Pub. No.: US 2016/0027105 A1
(43) Pub. Date: Jan. 28, 2016

(54) GLOBAL ACCOUNT OPENING MATRIX

(71) Applicant: Bank of America Corporation, Charlotte, NC (US)

(72) Inventors: Rahul Mahajan, Gurgaon (IN); Raghavendran Narasimhan, Hyderabad (IN); Venkatesh Naidu, Hyderabad (IN); Navjit Moran, Delhi (IN)

(21) Appl. No.: 14/340,157

(22) Filed: Jul. 24, 2014

(51) Int. Cl. G06Q 40/02; G06F 3/0484

(52) U.S. Cl. CPC G06Q 40/02; G06F 3/04842

(57) ABSTRACT

The present invention is directed to a global account opening matrix—a software-based system that enables an associate associated with a financial institution to quickly and efficiently determine which documents are required for opening a financial account in a particular country. The associate, via an interface, selects at least one country in which a financial account is to be opened. The system determines at least one document required for opening a financial account in the selected at least one country and may provide the associate with an option to view and/or download the at least one required document. Indicators associated with the at least one required document communicate to the associate which pieces of information are required for execution of the at least one required document. The system then generates a print-ready report that identifies the at least one required document for each of the selected countries.

### FIELD OF THE INVENTION

The present invention embraces a system for determining which documents are required for opening a financial account in one or more countries. The system typically includes a processor, a memory, and a module stored in the memory. The module is typically configured to enable a user to select one or more countries in which an account is to be opened, receive a user selection of one or more countries, determine one or documents required for opening an account in the user-selected one or more countries, and generate a comparative report identifying one or more documents required for opening an account in the user-selected one or more countries.

### BACKGROUND

Execution of a plurality of documents is typically required when opening a financial account. Furthermore, each country may have its own regulations and standards of executing required documents. Therefore, there is a need for improved ways of assisting with opening financial accounts.

### BRIEF SUMMARY

The present invention is directed to a global account opening matrix—a software-based system that enables an associate associated with a financial institution to quickly and efficiently determine which documents are required for opening a financial account in one or more countries. The associate, via an interface, selects at least one country in which a financial account is to be opened. The system determines at least one document required for opening a financial account in the selected at least one country and provides the associate with an option to view and/or download the at least one required document. Indicators associated with the at least one required document communicate to the associate which pieces of information are required for execution of the at least one required document. The system then generates a print-ready report that includes the at least one required document for each of the selected countries.

In some embodiments, a system is provided. The system comprises: a memory; a processor; and a module stored in memory, executable by a processor, and configured to: initiate presentation of an interface that enables a user to select one or more countries; receive from the user a selection of at least one country; determine at least one document required for opening a financial account in at least one country selected by the user; and generate a report comprising at least one document required for opening a financial account in at least one country selected by the user.

In some embodiments, initiating presentation of the interface comprises prompting the user with instructions for selecting at least one country, wherein the interface enables the user to select or deselect all countries listed on the interface.

In some embodiments, generating the report comprises generating at least one of a message, an email, a text message, a notification, an alert, a note, or a post, wherein at least one of the message, the email, the text message, the notification, the alert, the note, or the post is transmitted to at least one apparatus in response to generating the report.

In some embodiments, determining at least one document required for opening a financial account in at least one country selected by the user comprises determining at least one document not required for opening a financial account in at least one country selected by the user, wherein the report does not include the at least one document not required for opening a financial account in at least one country selected by the user as determined by the system.

In some embodiments, the report is generated in a print-friendly format, wherein generating the report comprises printing the report.

In some embodiments, the interface comprises a table of information associated with documents required for opening a financial account in all countries.

In some embodiments, information associated with each document includes at least one of a document name, a document type, a document source, a description, or remarks associated with a region or country, wherein the information associated with each document is modifiable by the user.

In some embodiments, receiving the selection of at least one country from the user comprises adding a column in the table for each selected country.

In some embodiments, determining at least one document required for opening a financial account in at least one country selected by the user comprises displaying at least one identifier in each added column associated with at least one country selected by the user.

In some embodiments, the interface includes a legend for color coding the at least one identifier, wherein the at least one identifier is configured to be colored based on a requirement for at least one of a resident or a non-resident of the at least one country selected by the user.

In some embodiments, the at least one identifier denotes a document format that is deemed acceptable for opening account in the at least one country selected by the user, wherein the document format comprises at least one of a certified copy of a document, a photocopy of a document, or an original document.

In some embodiments, the at least one identifier is highlighted, wherein the at least one highlighted identifier comprises at least one hyperlink that enables the user to access the at least one document required for opening a financial account in at least one country selected by the user, wherein the user is enabled to select the at least one hyperlink, wherein selection of the at least one hyperlink comprises initiating a download of at least one document.

In some embodiments, the interface comprises a table of information associated with documents required for opening a financial account in all countries, wherein receiving the selection of at least one country from the user comprises adding a column in the table for each selected country, wherein determining at least one document required for opening a financial account in at least one country selected by the user comprises displaying at least one identifier in each added column associated with at least one country selected by the user

In some embodiments, a method is provided. The method comprises: initiating, using a computing device processor, presentation of an interface that enables a user to select one or more countries; receiving, using a computing device processor, from the user a selection of at least one country; determining, using a computing device processor, at least one document required for opening a financial account in at least one country selected by the user; and generating, using a computing device processor, a report identifying at least one document required for opening a financial account in at least one country selected by the user.

In some embodiments, a computer program product is provided. The computer program product comprises a non-transitory computer-readable medium comprising code causing an apparatus to: initiate presentation of an interface that enables a user to select one or more countries; receive from the user a selection of at least one country; determine at least one document required for opening a financial account in at least one country selected by the user; and generate a report identifying at least one document required for opening a financial account in at least one country selected by the user.

The global account opening matrix (e.g., the system) of the present invention provides many benefits. First, the system saves the associate ample time in determining which documents are required for opening a financial account in one or more countries. Further, the system provides indicators which communicate to the associate which pieces of information are required for execution of the required documents, therefore streamlining instructions that the associate must provide to a customer when opening the financial account(s). Additionally, by linking the required documents into the system, the associate may quickly retrieve required documents. Lastly, generating a report of the required documents enables the associate to efficiently print out and/or transmit required documents to the customer for execution, a supervisor for review, or an account specialist for processing. All in all, the global account opening matrix of the present invention saves time in processing and ensures accuracy of determining any required documents for opening a financial account in one or more countries.

### BRIEF DESCRIPTION OF THE DRAWINGS

Having thus described embodiments of the invention in general terms, reference will now be made to the accompanying drawings, where:

FIG. 1 is an exemplary process flow 100 for providing a user with documents required to open a financial account in a particular country, in accordance with embodiments of the present invention;

FIG. 2 is an exemplary user interface 200 for enabling a user to select one or more countries in which a financial account is to be opened, in accordance with embodiments of the present invention;

FIG. 3 is an exemplary user interface 300 for a generated final report that includes documents required for opening a financial account in one or more selected countries, in accordance with embodiments of the present invention; and

FIG. 4 is an exemplary system environment 400 for executing functions associated with a global account opening matrix in accordance with embodiments of the present invention.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

In some embodiments, a “user” as used herein is an associate, an agent, a specialist, an account manager, a teller, or the like associated with the entity. In other embodiments, the user may not be associated with the entity and instead may be associated with a third party entity, such as a third party document processing firm, or the like.

The present invention is directed to a global account opening matrix—a software-based system that enables an associate associated with a financial institution to quickly and efficiently determine which documents are required for opening a financial account in a particular country. Typically, the associate receives a request from a customer (e.g., a client, an existing customer, a potential customer, or the like) in regards to opening a financial account in one or more countries. In response to receiving the request, the associate processes the request and, via an interface, selects at least one country in which a financial account is to be opened. The system determines at least one document required for opening a financial account in the selected at least one country and may provide the associate with an option to view and/or download the at least one required document. Indicators associated with the at least one required document communicate to the associate which pieces of information are required for execution of the at least one required document. The system then generates a print-ready report that includes information regarding the at least one required document for each of the selected countries.

The global account opening matrix (e.g., the system) of the present invention addresses an identified need in opening accounts in multiple countries. Specifically, information regarding documents required for opening an account in various countries is not readily obtainable, and there is no central repository of documents required for opening an account in multiple countries. The present invention addresses this identified need by not only providing a system that enables a user to quickly identify and compare required documents for multiple countries, but also by providing links to the required documents for easy user access.

The global account opening matrix (e.g., the system) of the present invention provides many benefits. First, the system saves the associate ample time in determining which documents are required for opening a financial account in one or more countries. Further, the system provides indicators for each required document that communicate to the associate which pieces of information are required for execution of the required documents, therefore streamlining instructions that the associate must provide to a customer when opening the financial account(s). Additionally, by linking at least some of the required documents into the system, the associate may quickly retrieve required documents. Lastly, generating a report of the required documents enables the associate to efficiently print out and/or transmit required documents to the customer for execution, a supervisor for review, or an account specialist for processing. Overall, the global account opening matrix of the present invention saves time in processing and ensures accuracy of determining any required documents for opening a financial account in one or more countries.

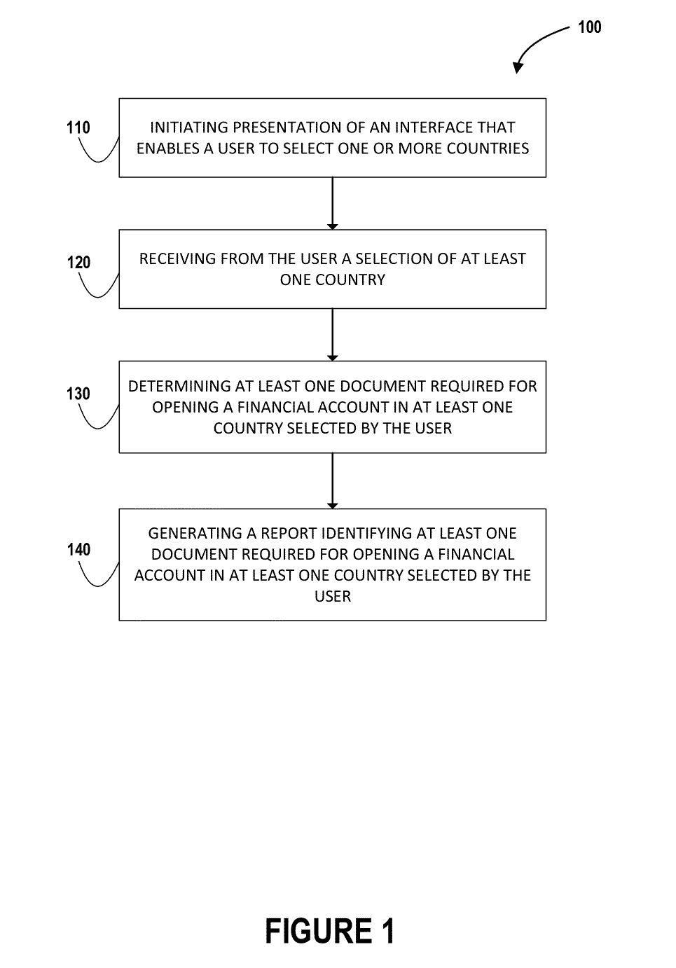

Referring now to the Figures, FIG. 1 illustrates an exemplary process flow 100 for providing a user with documents required to open a financial account in a particular country. At block 110, the process includes initiating presentation of an interface that enables a user to select one or more countries in which a financial account may be opened. At block 120, the process includes receiving from the user a selection of at least one country. At block 130, the process includes determining at least one document required for opening a financial account in at least one country selected by the user. At block 140, the process includes generating a report comprising information regarding at least one document required for opening a financial account in at least one country selected by the user.

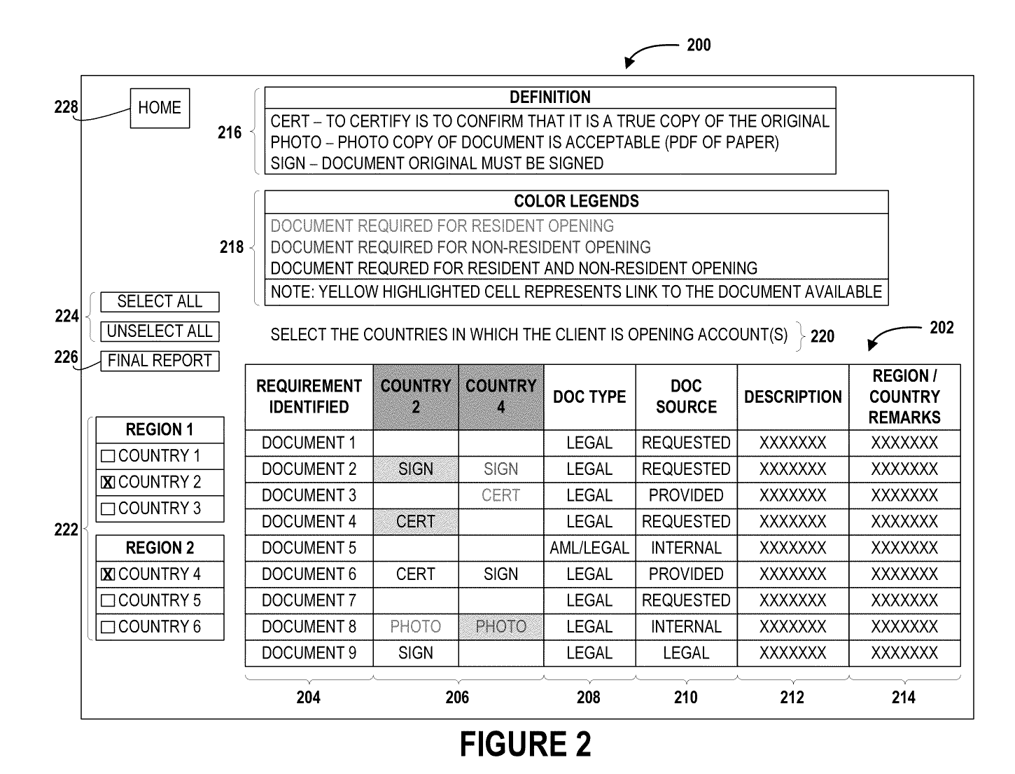

FIG. 2 illustrates an exemplary user interface 200 for enabling a user to select one or more countries in which a financial account is to be opened. The interface 200 includes a table 202 of information associated with documents required for opening one or more financial accounts in one or more countries. Typically, the table 202 is populated with a list of documents and information associated with and/or required for deposit account openings. The table 202 may also include documents and information associated with and/or required for other account openings (e.g., an investment account, a checking account, a savings account, or the like), client onboarding, account cancelation, or other transactions. In some embodiments, the list of documents and related information are stored in a database associated with and/or accessed by the system of the present invention, and then displayed to the user via the interface 200. In some embodiments, the table 202 may include a list of all documents in the database that may be required for opening an account.

The listing of documents and information in the table 202 may be edited, modified, updated, added to, or deleted from. For example, the user (or another user, such as an administrator) is enabled to add a new document to the table 202 (or a database associated with the system) that has recently been required for opening a financial account in a particular country.

Columns of the table 202 include a document name 204 (e.g., a title of a requirement document that may include notes that help the user identify the purpose of the document), user-selected countries 206 (e.g., countries that have been selected by the user as countries in which a financial account is to be opened), a document type 208 (e.g., a legal document, an internal document, a branch-specific document, or the like), a document source 210 (e.g., a notation of whether the document is internal, self-sourced, requested from a client or customer, a form that is or has been provided to a client or customer, a form that is or has been provided to a client or customer for execution purposes or completion, a legal document prepared by a legal team or the like), a description 212 (e.g., notes explaining the content or purpose of the required document), and remarks 214 (e.g., notes explaining country-specific or region-specific rules, guidelines, customs, or the like to aid in processing of a foreign account opening). Columns of the table 202 may be added, deleted, modified, or updated by the user or an administrator.

The selected countries 206 include one or more countries selected by the user. The selected countries 206 further include one or more identifiers that communicate to the user which documents are required for opening a financial account in the one or more selected countries. The identifiers may also indicate any additional information or actions required for each document. The identifiers may be text, an image, an icon, a check, an “X,” or another type of identifier. As the user selects or deselects countries, the list of selected countries 206 may be automatically updated (e.g., in real time).

A definition legend 216 provides the user with definitions of the one or more identifiers. For example, the identifiers may include “CERT,” which indicates to the user that a document required for opening a financial account in a selected country must be certified as a true copy of the original document. Alternatively, the identifiers may include “PHOTO,” which indicates to the user that a photo copy or a portable document format (PDF) of a document required for opening a financial account in a selected country is acceptable. Further, the identifiers may include “SIGN,” which indicates to the user that a document required for opening a financial account in a selected country must be an original signed document. In other embodiments, other indicators may be used in addition to or in place of the aforementioned indicators.

Also, the indicators may be colored as denoted by the color legend 218 to communicate to the user resident and non-resident requirements. In some embodiments, the indicators may be colored green to indicate that a document is required for opening an account for a resident customer (e.g., a resident of a selected country, an entity or corporation incorporated in a selected country, or the like). In other embodiments, the indicators may be colored blue to indicate that a document is required for opening an account for a non-resident customer (e.g., a non-resident of a selected country, an entity or corporation incorporated outside a selected country, or the like). Alternatively, the indicators may be colored red to indicate that a document is required for opening an account for both a resident customer and a non-resident customer. Other colors may also be used to communicate other document requirements.

Additionally, as noted in the color legend 218, the indicators may be highlighted. A highlighted indicator typically represents that a hyperlink is attached to the highlighted indicator. The hyperlink may point to a required document that is accessible by the system. So, for example, the user may click on or select the highlighted indicator associated with a document required for opening an account in a selected country, and the system may present the required document to the user. Alternatively, clicking on or selecting a highlighted indicator may initiate download of a required document, transmittal (e.g., email, messaging, or the like) of a required document, presentation of a required document via an interface, or the like.

The interface 200 further includes instructions 220 for prompting the user to select one or more countries in which a customer is opening an account. The interface 200 includes means 222, 224 for enabling the user to select one or more countries in which a financial account is to be opened. For example, the user may select one or more countries via a selection menu 222. The selection menu 222 includes a plurality of regions, and then a list of countries under each region. A selection box or other means for selection associated with each country is typically selectable by the user. The user may also be enabled to select all countries, or unselect all countries via controls 224. Thus, one country may be selected by the user, or a plurality of countries may be selected by the user.

When a country is selected by the user, a selected country 206 column is automatically inserted into the table 202 by the system that corresponds to the selected country. Deselecting a country may automatically remove a column associated with the deselected country from the selected country 206 columns in the table 202.

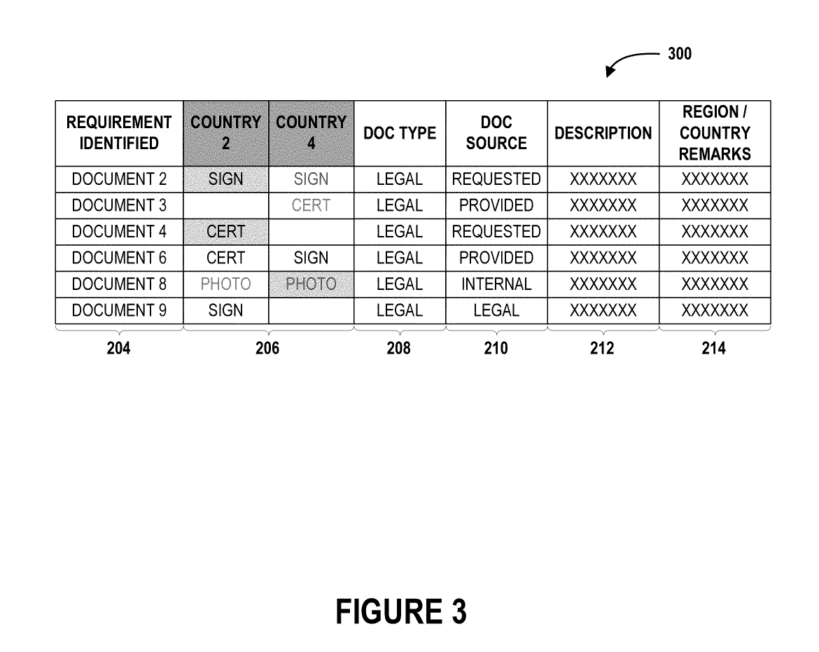

The interface 200 further includes a Final Report 226 button that, upon its selection by the user, is configured to initiate presentation of a second interface 300 as shown in FIG. 3. The second interface 300 includes a system-generated comparative report of documents required for opening a financial account in selected countries.

The report typically is generated based on the system's determination of required documents and information in the table 202, including a document name 204, one or more selected countries 206, a document type 208, a document source 210, a description 212, and remarks 214. In some embodiments, the report includes only the columns of the table 202 that are relevant to one or more selected countries. For example, the report would not include non-selected countries in the selected countries 206 columns. In other embodiments, the report includes only the rows associated with documents determined by the system to be required for opening a financial account in one or more selected countries. Alternatively, the report may include all rows and columns of the table 202.

The report displayed in FIG. 3 via the second interface 300 is typically generated by the system in a format that is printer-friendly or print-ready. In some embodiments, generating the report comprises printing the report. In other embodiments, generating the report comprises generating a transmitting a message (e.g., an email, an alert, a text message, a notification, or the like) comprising the report. For example, when the report is generated by the system, the system may also generate a message that comprises a printer-friendly version of the report. The message may then be transmitted to an administrator for review, a customer for execution of required documents, an apparatus associated with a second user, or the like. The report further enables the user to quickly compare documents and conditions required for opening a financial account in a specific country, or in multiple countries. Additionally, generating the report may comprise generating packets of documents determined to be required for opening an account in the one or more selected countries. A generated packet of documents may be transmitted to an apparatus associated with a customer, a supervisor, or the like.

The global account opening matrix (e.g., the system) of the present invention may be integrated with an existing software platform associated with the entity or a third party that is typically used for opening accounts. For example, the user may receive a request from a customer in regards to opening an account in a specific country. The request may be received by the user via an entity-specific software application devoted to financial account opening. Upon receipt of the request, the user may open the global account opening matrix (e.g., the system) of the present invention via an icon in the application to respond to the customer request. Alternatively, the global account opening matrix (e.g., the system) of the present invention may be integrated with an existing repository (e.g., a database) of documents known to be required for opening a financial account in specific countries.

Authentication may be required by the system at various times during operation of the system. The system prompts the user for at least one authentication credential (e.g., a password, a passcode, a personal identification number (PIN), an answer to a security question, a biometric input, readable indicia, a gesture, a user input, or the like). The system receives the at least one authentication credential and compares the received at least one authentication credential to a plurality of authentication credentials associated with authentication. The system determines at least a partial match between the at least one authentication credential and the plurality of authentication credentials associated with authentication. Based on determining a match, the system authenticates the user and executes an action in response. If no match is determined between the at least one authentication credential and the plurality of authentication credentials associated with authentication, the system may prompt the user for another authentication credential or deny the user from execution of an action (e.g., accessing the global account opening matrix).

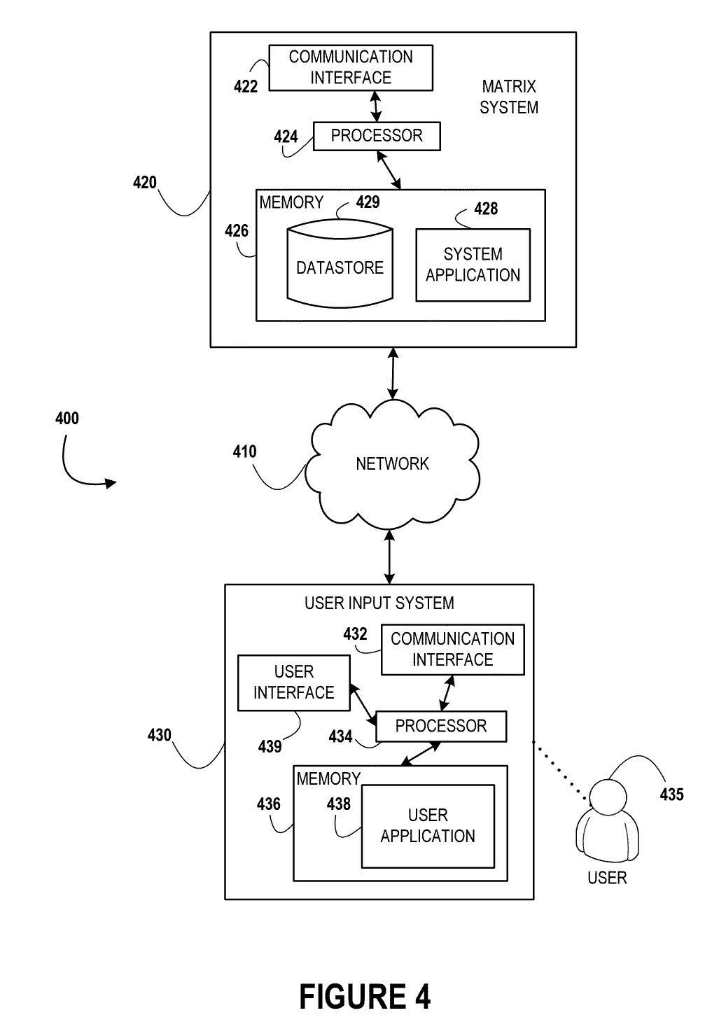

FIG. 4 is an exemplary block diagram illustrating technical components of a system 400 for implementing the global account opening matrix as described in the process flow 100 and as described in FIG. 1, as well as the exemplary interfaces 200, 300 as illustrated in FIGS. 2-3. As illustrated, the system environment 400 includes a network 410, a matrix system 420, and a user input system 430.

As shown in FIG. 4, the matrix system 420 and the user input system 430 are each operatively and selectively connected to the network 410, which may include one or more separate networks. In addition, the network 410 may include a telecommunication network, local area network (LAN), a wide area network (WAN), and/or a global area network (GAN), such as the Internet. It will also be understood that the network 410 is secure and may also include wireless and/or wireline and/or optical interconnection technology.

FIG. 4 also illustrates a matrix system 420, in accordance with an embodiment of the present invention. The matrix system 420 may refer to the “apparatus” or “matrix” described herein. The matrix system 420 may include any computerized apparatus that can be configured to perform any one or more of the functions of the matrix system 420 described and/or contemplated herein. In accordance with some embodiments, for example, the matrix system 420 may include a computer network, an engine, a platform, a server, a database system, a front end system, a back end system, a personal computer system, and/or the like. Therefore, the matrix system 420 may be a server managed by the entity. The matrix system 420 may be located at the facility associated with the entity or remotely from the facility associated with the entity. In some embodiments, such as the one illustrated in FIG. 4, the matrix system 420 includes a communication interface 422, a processor 424, and a memory 426, which includes a system application 428 and a datastore 429 stored therein. As shown, the communication interface 422 is operatively and selectively connected to the processor 424, which is operatively and selectively connected to the memory 426.

It will be understood that the system application 428 may be configured to implement any one or more portions of the various user interfaces and/or process flow described herein. The system application 428 may interact with the user application 438. It will also be understood that, in some embodiments, the memory includes other applications. It will also be understood that, in some embodiments, the system application 428 is configured to communicate with the datastore 429, the user input system 430, or the like.

It will be further understood that, in some embodiments, the system application 428 includes computer-executable program code portions for instructing the processor 424 to perform any one or more of the functions of the system application 428 described and/or contemplated herein. In some embodiments, the system application 428 may include and/or use one or more network and/or system communication protocols.

In addition to the system application 428, the memory 426 also includes the datastore 429. As used herein, the datastore 429 may be one or more distinct and/or remote datastores. In some embodiments, the datastore 429 is not located within the matrix system 420 and is instead located remotely from the matrix system 420. In some embodiments, the datastore 429 stores information or data described herein.

It will be understood that the datastore 429 may include any one or more storage devices, including, but not limited to, datastores, databases, repositories, and/or any of the other storage devices typically associated with a computer system. It will also be understood that the datastore 429 may store information in any known way, such as, for example, by using one or more computer codes and/or languages, alphanumeric character strings, data sets, figures, tables, charts, links, documents, and/or the like. Further, in some embodiments, the datastore 429 may include information associated with one or more applications, such as, for example, the system application 428, information associated with documents required to open a financial account or another type of account, or documents associated with other actions (e.g., closing an account, or the like). It will also be understood that, in some embodiments, the datastore 429 provides a substantially real-time representation of the information stored therein, so that, for example, when the processor 424 accesses the datastore 429, the information stored therein is current or substantially current.

It will be understood that the embodiment of the system environment 400 illustrated in FIG. 4 is exemplary and that other embodiments may vary. As another example, in some embodiments, the matrix system 420 includes more, less, or different components. As another example, in some embodiments, some or all of the portions of the system environment 400 may be combined into a single portion. Likewise, in some embodiments, some or all of the portions of the matrix system 420 may be separated into two or more distinct portions.

In addition, the various portions of the system environment 400 may be maintained for and/or by the same or separate parties. It will also be understood that the matrix system 420 may include and/or implement any embodiment of the present invention described and/or contemplated herein. For example, in some embodiments, the matrix system 420 is configured to implement any one or more of the embodiments of the process flows described and/or contemplated herein in connection any process flow described herein. Additionally, the matrix system 420 or the user input system 430 is configured to initiate presentation of any of the user interfaces described herein.

The user input system 430 may include any computerized apparatus that can be configured to perform any one or more of the functions of the user input system 430 described and/or contemplated herein. For example, the user 435 may use the user input system 430 to transmit and/or receive information or commands to and from the matrix system 420. In some embodiments, for example, the user input system 430 may include a personal computer system (e.g. a non-mobile or non-portable computing system, or the like), a mobile computing device, a personal digital assistant, a mobile phone, a tablet computing device, a network device, a wearable computing device, a sensor, and/or the like. As illustrated in FIG. 4, in accordance with some embodiments of the present invention, the user input system 430 includes a communication interface 432, a processor 434, a memory 436 having a user application 438 stored therein, and a user interface 439. In such embodiments, the communication interface 432 is operatively and selectively connected to the processor 434, which is operatively and selectively connected to the user interface 439 and the memory 436. In some embodiments, the user 435 may use the user application 438 to execute processes described with respect to the process flow and interfaces described herein. Specifically, the user application 438 executes the process flow described in FIG. 1.

Each communication interface described herein, including the communication interface 432, generally includes hardware, and, in some instances, software, that enables the user input system 430, to transport, send, receive, and/or otherwise communicate information to and/or from the communication interface of one or more other systems on the network 410. For example, the communication interface 432 of the user input system 430 may include a wireless transceiver, modem, server, electrical connection, and/or other electronic device that operatively connects the user input system 430 to another system such as the matrix system 420. The wireless transceiver may include a radio circuit to enable wireless transmission and reception of information. Each processor described herein, including the processor 434, generally includes circuitry for implementing the audio, visual, and/or logic functions of the user input system 430. For example, the processor may include a digital signal processor device, a microprocessor device, and various analog-to-digital converters, digital-to-analog converters, and other support circuits. Control and signal processing functions of the user input system 430 in which the processor resides may be allocated between these devices according to their respective capabilities. The processor may also include functionality to operate one or more software programs based at least partially on computer-executable program code portions thereof, which may be stored, for example, in a memory device, such as in the user application 438 of the memory 436 of the user input system 430.

Each memory device described herein, including the memory 436 for storing the user application 438 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the matrix system 420 or the user input system 430 in which it resides to implement the functions of matrix system 420 or the user input system 430.

As shown in FIG. 4, the memory 436 includes the user application 438. In some embodiments, the user application 438 includes an interface for communicating with, navigating, controlling, configuring, and/or using the user input system 430. In some embodiments, the user application 438 includes computer-executable program code portions for instructing the processor 434 to perform one or more of the functions of the user application 438 described and/or contemplated herein. In some embodiments, the user application 438 may include and/or use one or more network and/or system communication protocols.

Also shown in FIG. 4 is the user interface 439. In some embodiments, the user interface 439 includes one or more output devices, such as a display and/or speaker, for presenting information to the user 435. In some embodiments, the user interface 439 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 435. In some embodiments, the user interface 439 includes the input and display devices of a mobile device, which are operable to receive and display information.

Also shown in FIG. 4 is a user 435 of the user input system 430. The user input system 430 may be any computing device. The user 435 may be a person who uses the user input system 430 to execute a user application 438. The user application 438 may be an application to communicate with the matrix system 420, perform a transaction, input information onto a user interface presented on the user input system 430, receive and/or transmit information, the like. The user application 438 and/or the system application 428 may incorporate one or more parts of any process flow described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system comprising:
a memory;
a processor; and
a module stored in memory, executable by a processor, and configured to:
initiate presentation of an interface that enables a user to select one or more countries;
receive from the user a selection of at least one country;
determine at least one document required for opening a financial account in at least one country selected by the user; and
generate a report identifying at least one document required for opening a financial account in at least one country selected by the user.

2. The system of claim 1, wherein initiating presentation of the interface comprises prompting the user with instructions for selecting at least one country, wherein the interface enables the user to select or deselect all countries listed on the interface.

3. The system of claim 1, wherein generating the report comprises generating at least one of a message, an email, a text message, a notification, an alert, a note, or a post, wherein at least one of the message, the email, the text message, the notification, the alert, the note, or the post is transmitted to at least one apparatus in response to generating the report.

4. The system of claim 1, wherein determining at least one document required for opening a financial account in at least one country selected by the user comprises determining at least one document not required for opening a financial account in at least one country selected by the user, wherein the report does not include the at least one document not required for opening a financial account in at least one country selected by the user as determined by the system.

5. The system of claim 1, wherein the report is generated in a print-friendly format, wherein generating the report comprises printing the report.

6. The system of claim 1, wherein the interface comprises a table of information associated with documents required for opening a financial account in all countries.

7. The system of claim 6, wherein information associated with each document includes at least one of a document name, a document type, a document source, a description, or remarks associated with a region or country, wherein the information associated with each document is modifiable by the user.

8. The system of claim 6, wherein receiving the selection of at least one country from the user comprises adding a column in the table for each selected country.

9. The system of claim 8, wherein determining at least one document required for opening a financial account in at least one country selected by the user comprises displaying at least one identifier in each added column associated with at least one country selected by the user.

10. The system of claim 9, wherein the interface includes a legend for color coding the at least one identifier, wherein the at least one identifier is configured to be colored based on a requirement for at least one of a resident or a non-resident of the at least one country selected by the user.

11. The system of claim 9, wherein the at least one identifier denotes a document format that is deemed acceptable for opening account in the at least one country selected by the user, wherein the document format comprises at least one of a certified copy of a document, a photocopy of a document, or an original document.

12. The system of claim 9, wherein the at least one identifier is highlighted, wherein the at least one highlighted identifier comprises at least one hyperlink that enables the user to access the at least one document required for opening a financial account in at least one country selected by the user, wherein the user is enabled to select the at least one hyperlink, wherein selection of the at least one hyperlink comprises initiating a download of at least one document.

13. A method comprising:
initiating, using a computing device processor, presentation of an interface that enables a user to select one or more countries;
receiving, using a computing device processor, from the user a selection of at least one country;
determining, using a computing device processor, at least one document required for opening a financial account in at least one country selected by the user; and
generating, using a computing device processor, a report identifying at least one document required for opening a financial account in at least one country selected by the user.

14. The method of claim 13, wherein the interface comprises a table of information associated with documents required for opening a financial account in all countries, wherein receiving the selection of at least one country from the user comprises adding a column in the table for each selected country, wherein determining at least one document required for opening a financial account in at least one country selected by the user comprises displaying at least one identifier in each added column associated with at least one country selected by the user.

15. The method of claim 14, wherein the interface includes a legend for color coding the at least one identifier, wherein the at least one identifier is configured to be colored based on a requirement for at least one of a resident or a non-resident of the at least one country selected by the user.

16. The method of claim 14, wherein the at least one identifier denotes a document format that is deemed acceptable for opening account in the at least one country selected by the user, wherein the document format comprises at least one of a certified copy of a document, a photocopy of a document, or an original document.

17. A computer program product comprising a non-transitory computer-readable medium comprising code causing an apparatus to:
initiate presentation of an interface that enables a user to select one or more countries;
receive from the user a selection of at least one country;
determine at least one document required for opening a financial account in at least one country selected by the user; and
generate a report identifying at least one document required for opening a financial account in at least one country selected by the user.

18. The computer program product of claim 17, wherein the interface comprises a table of information associated with documents required for opening a financial account in all countries, wherein receiving the selection of at least one country from the user comprises adding a column in the table for each selected country, wherein determining at least one document required for opening a financial account in at least one country selected by the user comprises displaying at least one identifier in each added column associated with at least one country selected by the user.

19. The computer program product of claim 18, wherein the interface includes a legend for color coding the at least one identifier, wherein the at least one identifier is configured to be colored based on a requirement for at least one of a resident or a non-resident of the at least one country selected by the user.

20. The computer program product of claim 18, wherein the at least one identifier denotes a document format that is deemed acceptable for opening account in the at least one country selected by the user, wherein the document format comprises at least one of a certified copy of a document, a photocopy of a document, or an original document.
